(19) United States
(12) Patent Application Publication
(10) Pub. No.: US 2007/0085695 A1
(43) Pub. Date: Apr. 19, 2007

(54) Natural unterine sound producing crib liner

(76) Inventor: Meena Nerurkar, Newtown, PA (US)

Correspondence Address: GOLDSTEIN LAW OFFICES, P.C., 2071 CLOVE ROAD - 204, STATEN ISLAND, NY, 10304, US

(21) Appl. No.: 11/546,068

(22) Filed: Oct. 11, 2006

Related U.S. Application Data
(60) Provisional application No. 60/725,273, filed on Oct. 11, 2005.

(51) Int. Cl. G08B 25/08; A47D 7/00; G08B 23/00

(52) U.S. Cl. 340/692; 340/573.1; 5/93.1

(57) ABSTRACT

A crib liner, including a base and upstanding walls that create a cavity for containing an infant. The crib liner includes a playback device that is capable of recording natural heartbeat sounds from the mother of the infant, and reproducing those sounds through speakers located within the upstanding walls, for soothing the infant.

### CROSS REFERENCES AND RELATED SUBJECT MATTER

This application is a continuation of provisional patent application Ser. No. 60/725,273, filed in the United States Patent Office on Oct. 11, 2005.

### BACKGROUND OF THE INVENTION

The invention relates to a natural uterine sound producing crib liner. More particularly, the invention relates to a crib liner that soothes an infant by reproducing the mother's uterine sounds along with the heartbeat of the mother.

While in the womb, a fetus is safe, warm, and well protected. Leaving the womb as an infant can be extremely traumatic. Bright lights and unfamiliar sounds can be extremely frightening to the child.

In recent years, significant attention has been given to infant mortality, occurring through what is known as SIDS (Sudden Infant Death Syndrome). Although the causes of SIDS have still not be conclusively determined, there is a suggestion that environmental trauma can be a cause or contributing factor.

U.S. Pat. No. 5,205,811 to Fornarelli appears to disclose an infant's baby blanket with a cavity for receiving a heartbeat simulator device.

U.S. Pat. No. 4,941,453 to Shakas appears to show a hammock assembly for an infant with a sonic device attached to the sheet for generating an impulse to simulate a heartbeat.

U.S. Pat. No. 6,004,259 to Sedaro appears to show a means for a mother to record her own heartbeat that is subsequently played beside a crib to simulate her presence.

U.S. Pat. No. 4,785,797 to Cuervo appears to show a means for soothing an infant by repeating sounds using a sound generator that are attached to the crib.

While these units may be suitable for the particular purpose employed, or for general use, they would not be as suitable for the purposes of the present invention as disclosed hereafter.

### SUMMARY OF THE INVENTION

It is an object of the invention to produce a crib liner that helps acclimate a child to the world outside of the womb. Accordingly, the crib liner is capable of producing natural uterine sounds that comfort the child by reminding the child of the womb.

It is another object of the invention to provide a crib liner that produces sounds associated with the mother. Accordingly, the crib liner produces heartbeat and uterine sounds through the walls of the crib liner.

It is a further object of the invention to provide a crib liner that can reproduce heartbeat, uterine and placental sounds from the mother of the infant. Accordingly, the crib liner can record uterine, placental and heartbeat sounds directly from the mother, and then subsequently reproduce those sounds for the infant.

The invention is a crib liner, including a base and upstanding walls that create a cavity for containing an infant. The crib liner includes a playback device that is capable of recording natural uterine and heartbeat sounds from the mother of the infant, and reproducing those sounds through speakers located within the upstanding walls, for soothing the infant.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the drawings, like elements are depicted by like reference numerals. The drawings are briefly described as follows.

FIG. 1 is a diagrammatic perspective view, illustrating the crib liner, per se.

FIG. 2 is a functional block diagram, illustrating major components of the present invention.

### DETAILED DESCRIPTION OF THE PREFERRED EMBODIMENTS

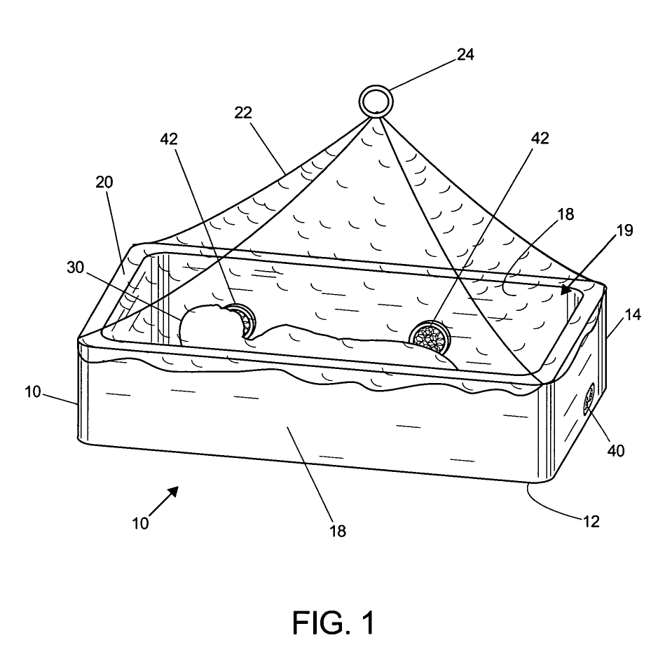

FIG. 1 illustrates a crib liner 10 having a base 12, and upstanding walls that extend upwardly from the base 12 and include a front wall 14, a rear wall 16, and a pair of side walls 18. A top ledge 20 is contiguous to the front wall 14, rear wall 16, and side walls 18. Preferably the base 12 and upstanding walls are made of a soft material, such as foam, or are constructed of a filled fabric casing—like a mattress. The walls 14, 16, 18, and base 12 of the crib liner create a cavity 19 which is sized to accommodate an infant 30 upon the base 12 and within the upstanding walls. A mesh covering 22 is preferably provided to engage the top ledge 20 so as to selectively fully cover the cavity 19 and provide protection to the infant 30. The mesh covering 22 may be supported in a canopy like configuration using a support ring 24 centrally located on the covering 22.

In accordance with the goals of the present invention, the crib liner 10 includes an audio playback device 40 which is capable of producing audible sounds through speakers 42 located within the side walls 18. The audio playback device 40 preferably produces natural sounds from the womb. In particular, the audio playback device produces heartbeat sounds to remind the infant 30 of its mother.

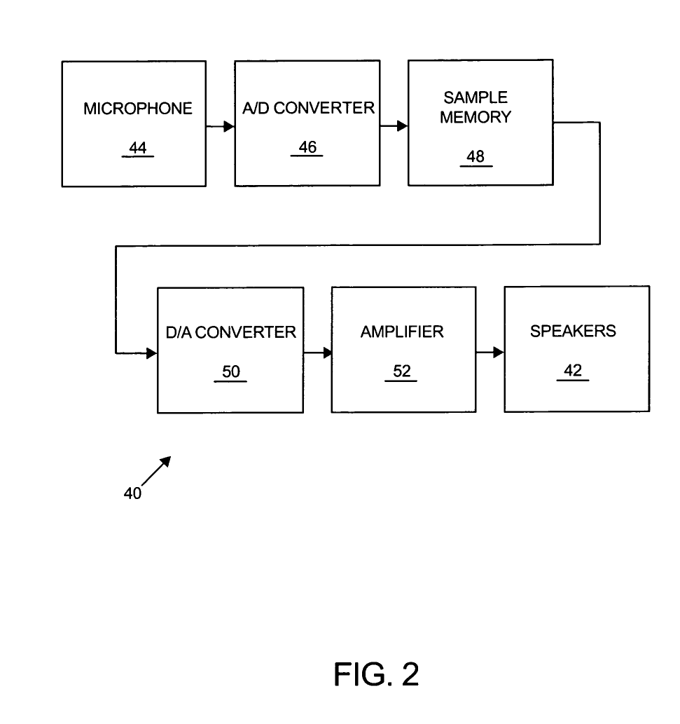

In order to best simulate heartbeat sounds that are familiar to the infant, in accordance with the goals of the present invention, the playback device 40 may be configured to record heartbeat and uterine sounds from the actual mother of the infant. Referring then to FIG. 2, the playback device 40 includes a microphone 44 for detecting heartbeat noises of the mother. The microphone 44 employed herein is preferably a biomedical device configured to record sounds as they are heard by an infant in the womb. In this regard, the microphone 44 may be designed to pickup sounds when placed upon the abdomen of the mother. The microphone produces an analog electric signal that is measured and sampled by an A/D converter 46 at an appropriate sample rate to accurately reproduce the heartbeat and uterine sound along with harmonics that are readily detectable by the infant. Data samples from the A/D converter are stored in sample memory 48 for later playback. Then, when the infant is within the cavity 19 and audio playback is desired, the data samples from the sample memory 48 are supplied to a D/A converter 50 to produce an audio signal, which is raised by an amplifier 52 to a voltage level suitable for driving the speakers 42.

Another embodiment and mode of use is described as follows: During pregnancy when the pregnant woman goes to an obstetrician's office, he/she checks the pregnant patient's belly. At that time, he/she also checks for the baby's well being by listening to the baby's heartbeats by a special instrument called a “hand held Doppler”. Similar beats are audible during ultrasound diagnostic tests, conducted during pregnancy. During this test, even the expectant mother's pulse beats and placental sounds are audible. The patient, during such office visits, can record the uterine sounds on an audio recorder of any suitable type. In addition, by using a simple recording device she can also record her own heartbeats on the same recording device. By combining the above two recorded sounds, a cassette or a CD could be made having the sounds, which would subsequently be played using a cassette or CD player, amplified, and played into the crib through the speaker(s) of the present invention.

In conclusion, herein is presented a natural uterine sound and heartbeat reproducing crib liner. The invention is illustrated by example in the drawing figures, and throughout the written description. It should be understood that numerous variations are possible, while adhering to the inventive concept. Such variations are contemplated as being a part of the present invention.

What is claimed is:

1. A crib liner, for holding an infant, and producing natural uterine sounds, comprising:
a base and four upstanding walls that are made of a soft material and create a cavity for accommodating the infant upon the base and within the upstanding walls, a top ledge is contigous to the four upstanding walls;
an audio playback device for producing natural uterine sounds, including a speaker located in one of the upstanding walls and the base, for audibly providing said natural uterine sounds to the infant.

2. The crib liner as recited in claim 1, wherein the audio playback device is configured to record natural uterine sounds, digitally store the natural uterine sounds, and reproduce the natural uterine sounds through the speaker.

3. The crib liner as recited in claim 2, wherein the audio playback device further comprises a microphone for recording uterine sounds from the mother of the infant.

4. The crib liner as recite in claim 3, wherein the audio playback device further comprises an A/D converter connected to the microphone for converting audio signals from the microphone into digital data, and sample memory for storing the digital data.

5. A crib liner audio playback method, for use by a mother and infant, using a crib liner having an audio playback device, comprising the steps of:
recording uterine sounds of the mother;
storing recorded uterine sounds in the playback device;
placing the infant in the crib liner; and
playing the uterine sounds back to the infant.
